(19) United States
(12) Patent Application Publication
(10) Pub. No.: US 2012/0234131 A1
(43) Pub. Date: Sep. 20, 2012

(54) DUAL-MASS FLYWHEEL LOCK-OUT CLUTCH

(75) Inventors: Darrell Lee Robinette, Fenton, MI (US); William L. Cousins, Ortonville, MI (US); Paul A. Piorkowski, Belleville, MI (US)

(73) Assignee: GM GLOBAL TECHNOLOGY OPERATIONS LLC, Detroit, MI (US)

(21) Appl. No.: 13/048,983

(22) Filed: Mar. 16, 2011

(51) Int. Cl. F16C 15/00; F16D 43/04

(52) U.S. Cl. 74/572.2

(57) ABSTRACT

A dual-mass flywheel is provided for a vehicle drivetrain having an internal combustion engine and a transmission. The dual-mass flywheel includes a primary mass adapted for connection to the engine and a secondary mass operatively connected to the primary mass and adapted for connection to the transmission. The clutching mechanism is configured to lock the secondary mass to the primary mass up to a threshold speed of the engine to reduce noise, vibration, and harshness (NVH) during start up of the engine. The clutching mechanism is also configured to release the secondary mass from the primary mass above the threshold speed. A motor vehicle employing the disclosed dual-mass flywheel is also provided.

### TECHNICAL FIELD

The invention relates to a dual-mass flywheel lock-out clutch mechanism.

### BACKGROUND

A flywheel is typically a mechanical, disc-shaped device that is characterized by a significant moment of inertia, and is frequently used as a storage device for rotational energy.

Because of the flywheel's moment of inertia, the flywheel typically resists change in its rotational speed. Accordingly, a flywheel may be used to smooth out a rotation of a shaft, for example a crankshaft of an internal combustion engine, when a fluctuating torque is exerted by a power source, such as by the engine's reciprocating pistons.

Some flywheels are configured as a single or a unitary mass, while others have a dual-mass design. In motor vehicles, dual-mass flywheels are typically used to reduce transmission gear rattle, reduce gear change/shift effort, and increase fuel economy by allowing high engine torque operation at low engine speeds in addition to smoothing out the operation of the engine.

### SUMMARY

A dual-mass flywheel is provided for a vehicle drivetrain having an internal combustion engine and a transmission. The dual-mass flywheel includes a primary mass adapted for connection to the engine and a secondary mass operatively connected to the primary mass and adapted for connection to the transmission. A clutching mechanism is configured to lock the secondary mass to the primary mass up to a threshold speed of the engine to reduce noise, vibration, and harshness (NVH) during start up of the engine. The clutching mechanism is also configured to release the secondary mass from the primary mass above the threshold speed.

The clutching mechanism may include a spring-loaded weighted element configured to lock the secondary mass to the primary mass up to the threshold speed. The clutching mechanism may also be configured to be activated by a centrifugal force to release the secondary mass from the primary mass above the threshold speed.

The weighted element may include a friction surface configured to lock the secondary mass to the primary mass up to the threshold speed. The weighted element may be part of a brake device, a sprag device, or a dog clutch configured to lock the secondary mass to the primary mass up to the threshold speed.

The secondary mass may be connected to the primary mass via a spring-damper system. Accordingly, the spring-damper system may establish a resonant frequency of the secondary mass relative to the primary mass. In such a case, the threshold speed may be set above the resonant frequency.

The clutching mechanism may be arranged internally within the dual-mass flywheel between the secondary mass and the primary mass.

A motor vehicle employing the disclosed dual-mass flywheel is also provided.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a motor vehicle drivetrain including a dual-mass flywheel having a clutching mechanism for locking the secondary mass to the primary mass;

FIG. 2 is a schematic diagram of a first embodiment of the dual-mass flywheel depicted in FIG. 1, clutching mechanism shown in an engaged state;

FIG. 3 is a schematic diagram of the first embodiment of the dual-mass flywheel depicted in FIG. 2, clutching mechanism shown in a disengaged state;

FIG. 4 is a schematic diagram of a second embodiment of the dual-mass flywheel depicted in FIG. 1, clutching mechanism shown in an engaged state;

FIG. 5 is a schematic diagram of the second embodiment the dual-mass flywheel depicted in FIG. 4, clutching mechanism shown in a disengaged state;

FIG. 6 is a schematic diagram of a third embodiment of the dual-mass flywheel depicted in FIG. 1, clutching mechanism shown in an engaged state; and

FIG. 7 is a schematic diagram of the third embodiment the dual-mass flywheel depicted in FIG. 6, clutching mechanism shown in a disengaged state.

### DETAILED DESCRIPTION

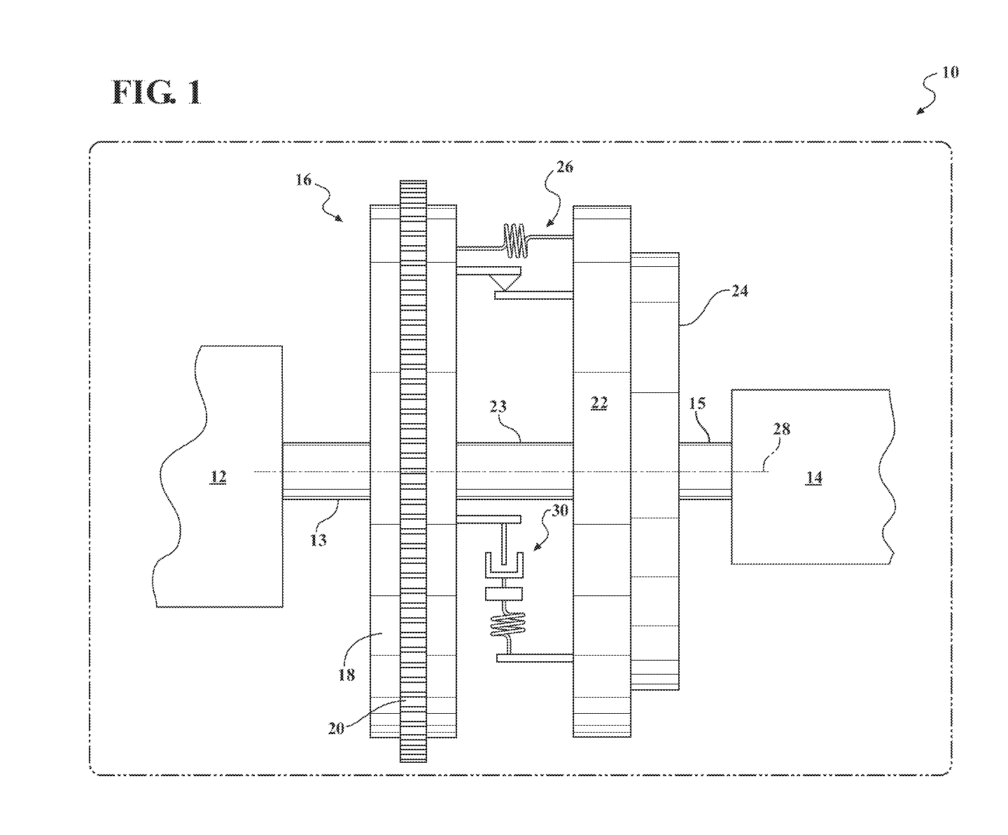

Referring to the drawings, wherein like reference numbers refer to like components, FIG. 1 shows a schematic view of a motor vehicle 10 which includes a drivetrain adapted for propelling the vehicle. The drivetrain includes an internal combustion engine 12, a transmission 14, and may include a propeller shaft and a differential for transmitting engine torque from the transmission to one or more driven wheels (not shown). The engine 12 may be a spark ignition or a compression ignition type, and includes an output shaft 13, such as a crankshaft. The engine 12 is operatively connected to the transmission 14 via a dual-mass flywheel 16.

In general, dual-mass flywheels are designed to filter out engine vibration before it is transmitted to the rest of the vehicle drivetrain. Dual-mass flywheels also reduce some of the jarring and stress on the transmission and remainder of the drivetrain during operation of the vehicle. Dual-mass flywheels are tuned systems and are typically matched to the torque curve and the resonant characteristics of the engine, as well as to the load curves of the particular vehicle. Dual-mass flywheels work by having a set of springs and a set of friction elements inserted between two rotating masses, a primary mass and a secondary mass. The springs are generally sized to dissipate some of the angular vibration from the engine under load conditions, while the friction elements are designed to provide frictional hysteresis to control and attenuate the relative displacement between the primary and the secondary masses. The dual-mass flywheel may also include an over torque friction release, such that if the flywheel is suddenly overloaded, for example when the vehicle drive wheels encounter a rapid increase in traction, rather than damaging the springs, the friction release will slip.

The dual-mass flywheel 16 includes a primary mass 18 that is adapted for connection to the output shaft 13, such that when attached to the engine 12, as shown, the dual-mass flywheel rotates at the same speed as the engine. The dual-mass flywheel 16 is typically attached to the output shaft 13 via fasteners such as bolts or screws (not shown). A ring gear 20 having a specific gear tooth profile and spacing is arranged on the outer perimeter of the primary mass 18. The ring gear 20 is typically characterized by an outer diameter that is designed to facilitate effective starting of the engine 12 by an appropriate starting device (not shown), as understood by those skilled in the art. The transmission includes an input shaft 15. The dual-mass flywheel 16 also includes a secondary mass 22 that is adapted for connection to the input shaft 15 of the transmission. As shown, the secondary mass is connected to the input shaft 15 via a torque transmitting device 24, such as either a manually or an automatically releasable clutch, to thus communicate the torque produced by the engine 12 to the transmission 14.

The secondary mass 22 is operatively connected to the primary mass 18 via a radial spring and damper system 26. The spring and damper system 26 is tuned to filter out vibrations during normally encountered operating modes of the vehicle 10, such as during vehicle drive, i.e., when torque of the engine 12 is applied to accelerate the vehicle, and during coast, i.e., when vehicle mass is used to decelerate the engine. The spring-damper system 26 also establishes a resonant frequency of the secondary mass 22 relative to the primary mass 18. The primary mass 18 is piloted on a hub 23 of the secondary mass 22 for rotation about a common axis 28.

The dual-mass flywheel 16 also includes a clutching mechanism 30. The clutching mechanism 30 is configured to lock the secondary mass 22 to the primary mass 18 up to a threshold speed of the engine 12, wherein the threshold speed is established above the resonant frequency of the dual-mass flywheel 16. In other words, the clutching mechanism 30 is configured to lock-out the tuned dual-mass function of the flywheel 16 up to the threshold speed of the engine 12, to reduce noise, vibration, and harshness (NVH) during start up of the engine. The clutching mechanism 30 is additionally configured to release the secondary mass 22 from the primary mass 18 above the threshold speed of the engine 12 via a centrifugal force and restore the dual-mass function of the flywheel 16.

Typically, the resonant frequency of the dual-mass flywheel 16 occurs in the range up to about 500 revolutions per minute (RPM). Operation of the dual-mass flywheel 16 in the vicinity of the resonant frequency by the dual-mass flywheel 16 may cause damage to the flywheel itself by driving the secondary mass 22 to larger angular displacement with respect to the primary mass 18 than can be reliably accommodated by design. Additionally, operation of the dual-mass flywheel 16 in the vicinity of the resonant frequency may lead to damage to other drivetrain components, adversely influence combustion stability in the engine 12, and also generate notable discomfort to passengers of the vehicle 10.

The threshold speed of the engine 12 may be initially determined through theoretical computations based on the known dimensions and mass values of the primary and secondary masses 18, 22, as well as spring rates and frictional/damping characteristics of the spring and damper system 26. The setting of the threshold speed above the resonant frequency of the dual-mass flywheel 16 eliminates the possibility of the dual-mass function of the flywheel operating at or near its resonant frequency, especially during start up of the engine 12. A safety factor may be employed to ensure that the clutching mechanism 30 maintains the secondary mass 22 locked to the primary mass 18 until the resonant frequency of dual-mass flywheel 16 has been exceeded. The threshold speed of the engine 12 may be additionally finalized during evaluation and development testing of the vehicle 10.

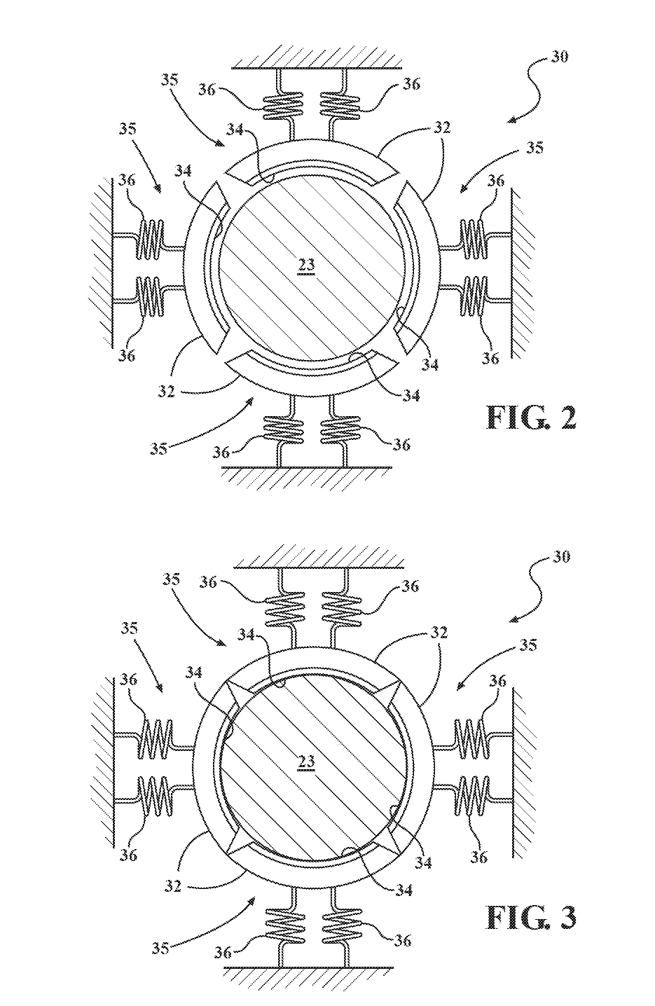

The clutching mechanism 30 is arranged internally within the dual-mass flywheel 16 between the secondary mass 22 and the primary mass 18. As shown in each of the embodiments depicted in FIGS. 2-4, the clutching mechanism 30 includes a weighted element 32 configured to lock the secondary mass 22 to the primary mass 18 up to the threshold speed. The weighted element 32 is operatively connected to the primary mass 18 and is spring-loaded in the spring set position against a hub 23 of the secondary mass 22 via one or more springs 36 to mechanically couple the secondary mass to the primary mass. The coupling of the primary and secondary masses 18, 22 by connecting the weighted element 32 and the hub 23 is intended to prevent relative rotational motion between the secondary mass and the primary mass when the spring(s) 36 is in the set position. Above the threshold rotational speed of the engine 12, the mass of the weighted element 32 is acted upon by a centrifugal force to thereby compress the spring(s) 36 and decouple the secondary mass 22 from the primary mass 18.

The mass of the weighted element 32 is established using a mathematical relationship “kΔx=−mrω²”. In the subject mathematical relationship, the factor “k” represents a total spring constant of the spring(s) 36, while the factor “Δx” represents the distance that the weighted element 32 must be displaced to disengage the hub 23. In the same relationship, the factor “m” represents the mass of the weighted element 32, the factor “r” represents the distance between the friction element 34 and the rotational axis 28, and the factor “ω” represents the threshold speed of the engine 12. Accordingly, the mass “m” of the weighted element 32 is established such that the weighted element will decouple from the hub 23 above the threshold speed of the engine 12, thus restoring the dual-mass function of the dual-mass flywheel 16. Thus, the clutching mechanism 30 is configured to be activated by a centrifugal force that is a function of the mass “m” of the weighted element 32, the threshold rotational speed “ω” of the engine 12, and the spring constant “k” of the spring(s) 36 to release the secondary mass 22 from the primary mass 18 above the threshold speed.

FIGS. 2-3 show a first specific embodiment of the clutching mechanism 30. The first embodiment of the clutching mechanism 30 is configured as a brake device 35. The weighted element 32 is part of the brake device 35. In the brake 35, the weighted element 32 includes a friction surface 34 that may be configured as an affixed friction lining. The weighted element 32 is operatively connected to the primary mass 18 and is spring-loaded via four springs 36 against the hub 23 of the secondary mass 22. The friction surface 34 is configured to generate a frictional connection between the weighted element 32 and the hub 23 to prevent relative rotational motion between the secondary mass 22 and the primary mass 18 when the four springs 36 are in their set position. FIG. 2 shows the first specific embodiment of the clutching mechanism 30 in an engaged state, while FIG. 3 shows the first specific embodiment of the clutching mechanism disengaged above the threshold speed of the engine 12. When the rotational speed of the engine 12 reaches the threshold speed, the mass of the weighted element 32 acts against and compresses each respective spring 42 according to the above-described mathematical relationship and withdraws and disengages the weighted element to unlock the secondary mass 22 from the primary mass 18.

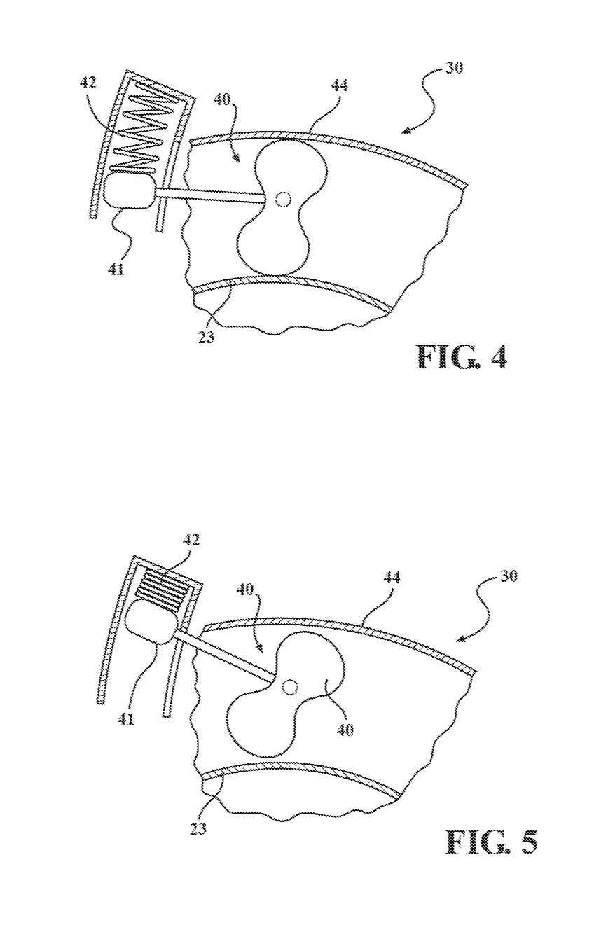

FIGS. 4-5 show a second specific embodiment of the clutching mechanism 30, which includes a plurality of sprag devices 40 configured to lock the secondary mass 22 to the primary mass 18 up to the threshold speed of the engine 12. At least one weighted element 41 is part of each sprag device 40. In each sprag device 40 the weighted element 41 is preloaded by a spring 42 that generally functions similarly to the springs 36 of the first embodiment shown in FIG. 2. Each sprag device 40 locks an outer race 44 arranged on the primary mass 18 with respect to the hub 23 of the secondary mass 22 when each spring 42 is in the set position. When the rotational speed of the engine 12 reaches the threshold speed, the mass of the weighted element 41 acts against and compresses each respective spring 42 according to the above-described mathematical relationship and rotates the sprag device to unlock the secondary mass 22 from the primary mass 18. Accordingly, the sprag devices 40 of the second embodiment are configured to lock the secondary mass 22 to the primary mass 18 up to the threshold speed of the engine 12, and to release the secondary mass from the primary mass 18 above the threshold speed.

Two rows of sprag devices 40 may be employed in order to achieve increased torque capacity of the clutching mechanism 30 of the second embodiment. Additionally, multiple rows of sprag devices 40 may also be employed such that one row is configured to act in an opposite direction relative to the other row in order to prevent rotation between the primary and secondary masses 18, 22 in either relative direction. FIG. 4 shows the second specific embodiment of the clutching mechanism 30 in an engaged state, while FIG. 5 shows the second specific embodiment of the clutching mechanism disengaged above the threshold speed of the engine 12.

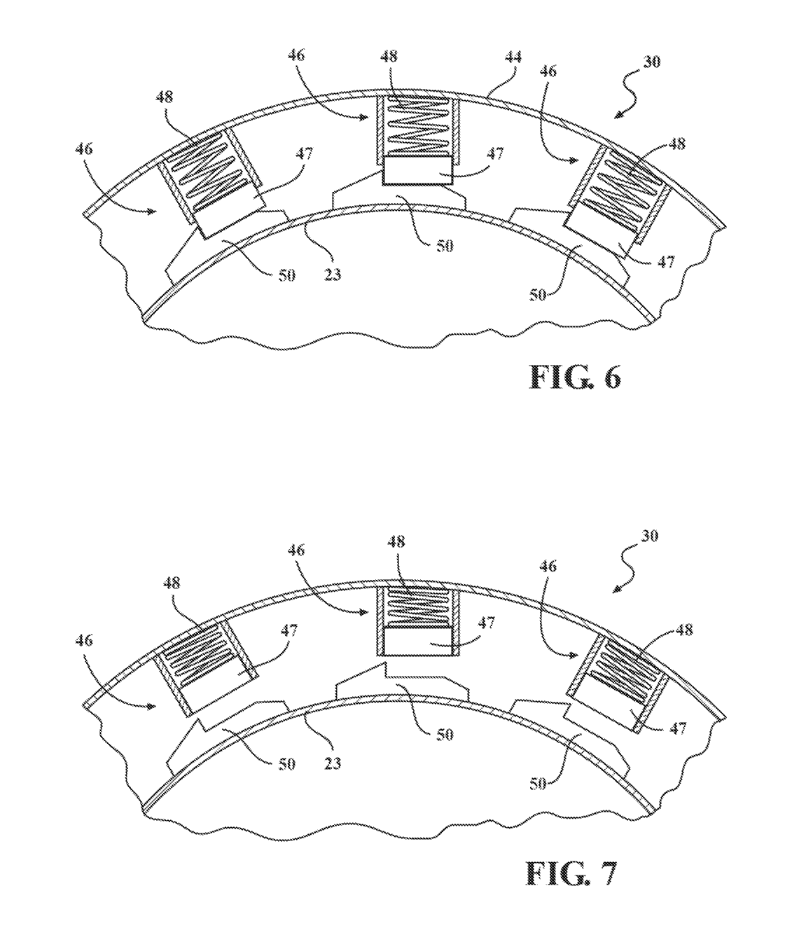

FIGS. 6-7 show a third specific embodiment of the clutching mechanism 30, which includes a plurality of dog clutch elements 46 configured to lock the secondary mass 22 to the primary mass 18 up to the threshold speed of the engine 12. At least one weighted element 47 is part of each dog clutch element 46. Each weighted element 47 is preloaded by a spring 48 that generally functions similarly to springs 36 and springs 42 of the first and second embodiments that are shown in FIGS. 2-3 and 4-5, respectively. Each dog clutch element 46 locks an outer race 44 arranged on the primary mass 18 against a complementary locking pawl 50 arranged on the hub 23 of the secondary mass 22 when each spring 48 is in the set position.

Two rows of dog clutch elements 46 and pawls 50 may be employed, wherein one row acts in an opposite direction relative to the other row in order to prevent rotation between the primary and secondary masses 18, 22 in either relative direction. When the rotational speed of the engine 12 reaches the threshold speed, the mass of each weighted element 47 acts against and compresses each respective spring 48 according to the above-described mathematical relationship and withdraws the weighted element to unlock the secondary mass 22 from the primary mass 18. Accordingly, the dog clutch elements 46 of the third embodiment are configured to lock the secondary mass 22 to the primary mass 18 up to the threshold speed of the engine 12, and to release the secondary mass from the primary mass 18 above the threshold speed. FIG. 6 shows the third specific embodiment of the clutching mechanism 30 in an engaged state, while FIG. 7 shows the third specific embodiment of the clutching mechanism disengaged above the threshold speed of the engine 12.

As depicted by the first, second, and third embodiments of FIGS. 2-7, the clutching mechanism 30 is configured to lock the secondary mass 22 to the primary mass 18 below the resonant frequency of dual-mass flywheel 16, and to release the secondary mass 22 from the primary mass 18 above the resonant frequency of the flywheel. Thus, the use of the clutching mechanism 30 permits the spring and damper system 26 to be specifically tuned to filter out vibrations during normally encountered operating modes of the vehicle 10, such as described above, without compromises being made for resonance of the dual-mass flywheel 16 during engine start-up.

The provision of the clutching mechanism 30 in the dual-mass flywheel 16 results in reduced NVH during the starting of the engine 12, which makes this feature particularly useful for frequent re-starting of the engine. Thus, although the dual-mass flywheel 16 may be employed in any vehicle having an engine, it is particularly beneficial in a vehicle where the engine 12 has a stop-start feature. As is known by those skilled in the art, a stop-start feature in an engine is where the engine is capable of being shut off when engine power is not required, but which may also be immediately restarted when engine power is again called upon to power the vehicle.

While the best modes for carrying out the invention have been described in detail, those familiar with the art to which this invention relates will recognize various alternative designs and embodiments for practicing the invention within the scope of the appended claims.

1. A dual-mass flywheel for a vehicle drivetrain having an internal combustion engine and a transmission, the dual-mass flywheel comprising:
a primary mass adapted for connection to the engine;
a secondary mass operatively connected to the primary mass and adapted for connection to the transmission; and
a clutching mechanism configured to lock the secondary mass to the primary mass up to a threshold speed of the engine to reduce noise, vibration, and harshness (NVH) during start up of the engine, and to release the secondary mass from the primary mass above the threshold speed.

2. The dual-mass flywheel of claim 1, wherein the clutching mechanism includes a spring-loaded weighted element configured to lock the secondary mass to the primary mass up to the threshold speed.

3. The dual-mass flywheel of claim 2, wherein the clutching mechanism is configured to be activated by a centrifugal force to release the secondary mass from the primary mass above the threshold speed.

4. The dual-mass flywheel of claim 3, wherein the weighted element includes a friction surface configured to lock the secondary mass to the primary mass up to the threshold speed.

5. The dual-mass flywheel of claim 3, wherein the weighted element is part of a brake device configured to lock the secondary mass to the primary mass up to the threshold speed.

6. The dual-mass flywheel of claim 3, wherein the weighted element is part of a sprag device configured to lock the secondary mass to the primary mass up to the threshold speed.

7. The dual-mass flywheel of claim 3, wherein the weighted element is part of a dog clutch configured to lock the secondary mass to the primary mass up to the threshold speed.

8. The dual-mass flywheel of claim 1, wherein the secondary mass is connected to the primary mass via a spring-damper system.

9. The dual-mass flywheel of claim 8, wherein the spring-damper system establishes a resonant frequency of the secondary mass relative to the primary mass, and the threshold speed is set above the resonant frequency.

10. The dual-mass flywheel of claim 1, wherein the clutching mechanism is arranged internally within the dual-mass flywheel between the secondary mass and the primary mass.

11. A drivetrain for a motor vehicle comprising:
an internal combustion engine;
a transmission for transferring torque of the engine for powering the vehicle; and
a dual-mass flywheel including:
a primary mass connected to the engine;
a secondary mass operatively connected to the primary mass and connected to the transmission; and
a clutching mechanism configured to lock the secondary mass to the primary mass up to a threshold speed of the engine to reduce noise, vibration, and harshness (NVH) during start up of the engine, and to release the secondary mass from the primary mass above the threshold speed.

12. The drivetrain of claim 11, wherein the clutching mechanism includes a spring-loaded weighted element configured to lock the secondary mass to the primary mass up to the threshold speed.

13. The drivetrain of claim 12, wherein the clutching mechanism is configured to be activated by a centrifugal force to release the secondary mass from the primary mass above the threshold speed.

14. The drivetrain of claim 13, wherein the weighted element includes a friction surface configured to lock the secondary mass to the primary mass up to the threshold speed.

15. The dual-mass flywheel of claim 13, wherein the weighted element is part of a brake device configured to lock the secondary mass to the primary mass up to the threshold speed.

16. The drivetrain of claim 13, wherein the weighted element is part of a sprag device configured to lock the secondary mass to the primary mass up to the threshold speed.

17. The drivetrain of claim 13, wherein the weighted element is part of a dog clutch configured to lock the secondary mass to the primary mass up to the threshold speed.

18. The drivetrain of claim 11, wherein the secondary mass is connected to the primary mass via a spring-damper system configured to establish a resonant frequency of the secondary mass relative to the primary mass and the threshold speed is set above the resonant frequency.

19. The drivetrain of claim 11, wherein the clutching mechanism is arranged internally within the dual-mass flywheel between the secondary mass and the primary mass.

20. A dual-mass flywheel for a vehicle drivetrain having an internal combustion engine and a transmission, the dual-mass flywheel comprising:
a primary mass adapted for connection to the engine;
a secondary mass operatively connected to the primary mass and adapted for connection to the transmission; and
a clutching mechanism configured to lock the secondary mass to the primary mass up to a threshold speed of the engine to reduce noise, vibration, and harshness (NVH) during start up of the engine, and to release the secondary mass from the primary mass above the threshold speed;
wherein:
the clutching mechanism includes a spring-loaded weighted element configured to lock the secondary mass to the primary mass up to the threshold speed and is configured to be activated by a centrifugal force to release the secondary mass from the primary mass above the threshold speed.
